(19) United States
(12) Patent Application Publication
(10) Pub. No.: US 2026/0185176 A1
(43) Pub. Date: Jul. 2, 2026

(54) MICROSTRUCTURE SIMULATION DURING HOT ROLLING

(71) Applicant: ArcelorMittal, Luxembourg (LU)

(72) Inventors: Ronan JACOLOT, Landonvillers (FR); Edgar Alejandro PACHON RODRIGUEZ, Le Ban Saint Martin (FR); Astrid PERLADE, Le Ban-Saint-Martin (FR)

(21) Appl. No.: 19/131,803

(22) PCT Filed: Nov. 27, 2023
(86) PCT No.: PCT/IB2023/061909

§ 371 Date: May 21, 2025

(30) Foreign Application Priority Data
Dec. 2, 2022 (WO) PCT/IB2022/061711

(51) Int. Cl. C21D 7/13

(52) U.S. Cl. CPC C21D 7/13

(57) ABSTRACT

A method to define a microstructure of a steel during the hot rolling, including at least three passes, including the steps of a) defining a representative grain size value of the steel before a first rolling pass, b) defining, at the end of a first inter-pass, a proportion of recrystallised and of non-recrystallised grains, representative grain size and dislocation density for the recrystallised and said non-recrystallised grains, c) defining, at the end of a second inter-pass, the proportion of the different types of grains, representative grain sizes and dislocation densities of the grains, d) defining, before a third rolling pass, a proportion of the representative recrystallised and non-recrystallised grain, a representative recrystallised grain and a representative non-recrystallised grain defined.

The present invention relates to a method to define a microstructure of a semi-finished steel product during a hot rolling, comprising at least three rolling passes.

### BACKGROUND

The hot rolling permits to reduce the thickness of a slab in order to obtain a desired geometry. This will entail a person skilled in the art to determine an optimal rolling pattern (i.e. number of rolling passes, rolling reduction) while taking into account metallurgical (i.e. temperature) and equipment constraints (i.e. couple, speed, force). Each of those parameters need to be established for each rolling pass so as to determine pre-sets.

### SUMMARY OF THE INVENTION

To this end, it is important to predict the steel microstructure during multi-pass hot rolling. Indeed, it enables to better determine the rolling loads and the dimensional feasibility of products when coupled with process models. Moreover, modelling the steel microstructure at the end of the multi-pass hot rolling is key to model subsequent phase transformations and precipitations.

In order to predict the recrystallised fraction, the grain size and the dislocation density throughout the multi-pass hot rolling, several models have been proposed.

For example, models have been developed to predict the flow behaviour of the steel during a hot rolling pass. Such model can be based on a physical description of the dislocation density evolution, where the accumulation of dislocation introduced by deformation and the annihilation by recovery determines the flow stress and the driving force for recrystallisation.

Other models have been developed to model the different recrystallisation processes, the recovery and the precipitation between two hot rolling passes. Such models can be based on a critical strain value and the temperature as proposed by Senuma.

Usually, the output of the model simulating the impact of the first hot rolling pass will be used as input for the modelling of the microstructure change during the first inter-pass, e.g. the time between the first and the second hot rolling passes. Then the output of the first inter-pass modelling will be used as input for the second model simulating the impact of the second hot rolling pass and so on for the modelling of the next inter-passes and the next rolling passes.

Unfortunately, such modelling can be performed offline but cannot be done online as the number of parameters is too large. Moreover, if such a model is coupled with a processing model, it is not usable on-line as the computing time does not allow to use the result of the modelling in the processing model. This is especially true when the number of passes is at least three.

Consequently, there is a need to improve the microstructure modelling of a multi-pass hot rolling.

The present invention aims to enable the on-line use of microstructure modelling through multi-pass hot rolling comprising at least three passes.

The present invention provides a method for determining characteristics of a microstructure of a semi-finished steel product during a hot rolling comprising at least three passes, the method comprising the steps of:
a) acquiring a representative grain size value for said steel product before a first rolling pass,
b) determining, at the end of a first inter-pass I₁,
   a proportion G_{R} of recrystallised grains g_{R}, and a proportion G_{N} of non-recrystallised grains g_{N},
   representative grain sizes ø_{R}, ø_{N}, and representative dislocation densities ρ_{R}, ρ_{N}, for said recrystallised grains g_{R} and said non-recrystallised grains g_{N},
c) determining, at the end of a second inter-pass I₂,
   a proportion G_{RR} of grains g_{RR}, being recrystallised at the end of said first inter-pass I₁, and recrystallised at the end of said second inter-pass I₂,
   a proportion G_{RN} of grains g_{RN}, being recrystallised at the end of said first inter-pass I₁ and non-recrystallised at the end of said second inter-pass I₂,
   a proportion G_{NR} of grains g_{NR}, being non-recrystallised at the end of said first inter-pass I₁ and recrystallised at the end of said second inter-pass I₂,
   a proportion G_{NN} of grains g_{NN} non-recrystallised at the end of said first inter-pass I₁ and non-recrystallised at the end of said second inter-pass I₂,
   representative grain sizes ø_{RR}, ø_{RN}, ø_{NR}, ø_{NN}, and representative dislocation densities ρ_{RR}, ρ_{RN}, ρ_{NR}, ρ_{NN}, of said grains g_{RR}, G_{RN}, g_{NR}, g_{NN},
d) determining, before a third rolling pass, the following characteristics of the microstructure of the semi-finished steel product:
   a proportion G_{R2} of representative recrystallised grains g_{R2}, and a proportion G_{N2} of representative non-recrystallised grains g_{N2},
   for the representative recrystallised grains g_{R2}: a grain size ø_{R2} and a dislocation density ρ_{R2} based on the grain proportions G_{RR}, G_{NR}, the representative grain sizes ø_{RR}, ø_{NR} and the dislocation densities ρ_{RR}, ρ_{NR} of the grains g_{RR} and g_{NR},
   for the representative non-recrystallised grains g_{N2}: a grain size ø_{N2} and a dislocation density ρ_{N2} based on the grain proportions G_{NN}, G_{RN}, the representative grain sizes ø_{RN}, ø_{NN} and the dislocation densities ρ_{NN}, ρ_{RN} of the grains g_{RN} and g_{NN}.

The present invention also provides an electronic device, comprising at least a processor and a memory, configured for executing the method described above.

The present invention also provides a hot rolling mill comprising one or more rolling stands and comprising the electronic device described above, the electronic device being configured for executing the methods as described above.

The present invention also provides a computer program comprising instructions whose execution on a computer makes the computer to execute the method presented above (the computer being possibly connected to sensors, actuators and/or to a controller of a hot rolling mill, depending on the detailed features of the method in question).

### BRIEF DESCRIPTION OF THE DRAWINGS

FIG. 1 illustrates four rolling stands (F1, F2, F3, F4) of a hot rolling mill.

FIG. 2 illustrates the first three rolling stand (F1, F2, F3) and the two first inter-passes (11, 12) of a hot rolling mill. The inter-pass I₁ extends from the first to the second hot rolling stand. The inter-pass I₂ extends from the second to the third hot rolling stand.

In FIG. 3 an average grain size determined according to the instant method is plotted against a corresponding measured grain size, for different hot rolling tests.

### DETAILED DESCRIPTION

Preferably, said semi-finished steel product, at the input of the hot rolling mill, is a slab, a billet or a bloom. Preferably, said hot rolling comprises from 10 to 15 hot rolling passes and produces a steel strip (in other words, the steel product is transformed into a steel strip, during the hot rolling). Preferably, said hot rolling comprises from 15 to 35 hot rolling passes and produces a steel plate.

In the first step of the method, step a), a representative grain size ø₀ of said steel is defined, more specifically acquired, before the first hot rolling pass. Because this is done prior to the first hot rolling pass, the steel is considered having recrystallised austenitic grains.

The representative grain size ø₀ can be any value deemed representative by the person skilled in the art. For example, the representative grain size can be the mean or the median value of the grain sizes. The representative grain size ø₀ may be input by an operator using a human-machine interface, or it may be read in a database where the grain size ø₀ is associated to a reference (e.g.: a reference number) identifying the steel product. In practice, the exact value of the representative grain size ø₀ does not influence much the characteristics of the microstructure of the semi-finished steel product, determined for this steel product at the end of the hot rolling, or in the course thereof. Indeed, after typically five to ten passes, this initial grain size is almost completely wiped out, replaced by grains sizes of newly formed grains (or by grain sizes of noticeably deformed grains). So, for rollings with more than ten, or even more than five passes, the exact value of ø₀ has no, or almost no influence on the microstructure determined according to the instant method.

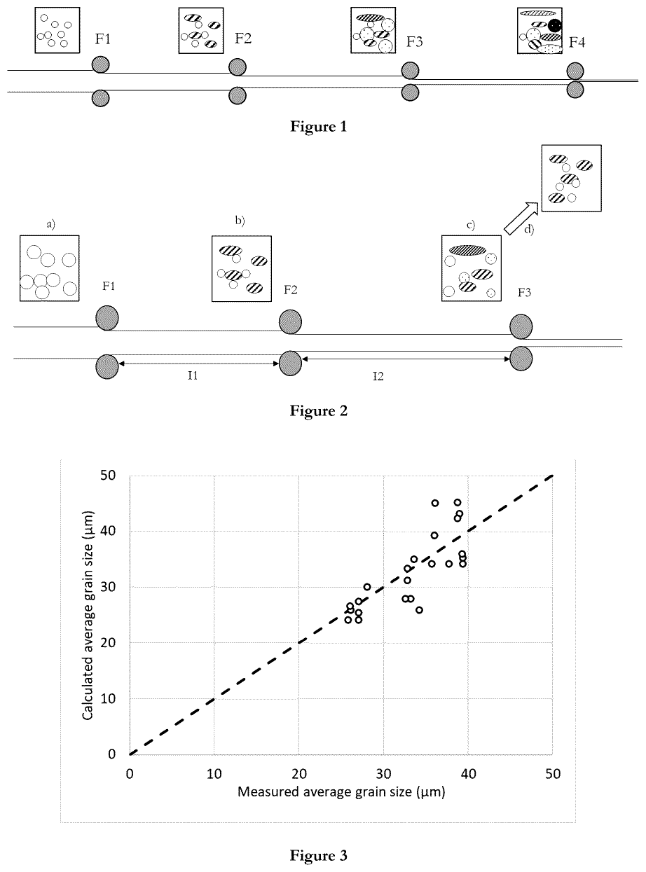

As illustrated in FIGS. 1 and 2, the steel is then hot rolled in the hot rolling stand F1 by which the steel is plastically deformed, and the grains are flattened and elongated. The rolling parameters, such as the strain rate and the rolling temperature, influence the recrystallisation. For example, dynamic and post dynamic recrystallisation can occur during the hot rolling.

Moreover, in the inter-pass I₁, the strain energy in the work hardened matrix is a driving force enabling the steel recovery. This strain energy, if high enough, can also trigger the static recrystallisation, leading to new grains at the former grain boundaries.

Consequently, at the end of the first inter-pass I₁, the microstructure can be predicted (which is done in step b)) by any model deemed appropriate by the person skilled in the art. The model outputs data comprising a proportion of non-recrystallised and recrystallised grains as well as a grain size and a dislocation density for said grains. In the detailed description below, by proportion it is meant a volume proportion (in other words a volume fraction).

Preferably, plastic deformation can be modelled using the teaching of Sinclair et al. in “A model for the grain size dependent work hardening of copper”, Scripta Materialia, 55, 739-742, 2006. Preferably, the dynamic recrystallisation can be modelled by the teaching of Senuma et al. in “Microstructural evolution of plain carbon steels in multiple hot working”, 7th Risø Int. Symp., (N.) Hansen, (D.-J.) Jensen, (T.) Leffers, (B.) Halph, Risø, Roskilde, Denmark, p. 547-52, 1986; the static recrystallisation, the recovery and the restoration can be modelled by the teaching of Zurob et al in “Modeling recrystallization of microalloyed austenite, effect of coupling recovery, precipitation and recrystallization”, Acta Materialia, 50, 3075-3092, 2002 and in “Rationalization of the softening and recrystallization behaviour of microalloyed austenite using mechanism maps”, Materials Science and Engineering, A 382, 64-81, 2004. The teaching of Perlade et al disclosed in “A model to predict the austenite evolution during hot strip rolling of conventional and Nb microalloyed steels”, La Revue de Métallurgie-Septembre 2008 can also be used to model the plastic deformation, the dynamic recrystallisation, the static recrystallisation, the recovery and the restoration. Grain sizes and the proportion of recrystalized grains resulting from the rolling may also be determined based on the teaching of the following article by Lissel et al. (in particular based on eqn 3 to 5 of Lissel et al.) “Prediction of the Microstructural Evolution during Hot Strip Rolling of Nb Microalloyed Steels”, Materials Science Forum Vols 558-559 (2007) pp 1127-1132 (doi: 10.4028/www.scientific.net/MSF.558-559.1127).

The model employed may in particular be a mean field model (as it is the case for instance in the model of Perlade et al.), in which each microstructure phase is described by one volume (one representative volume) with uniform material properties within said volume (in other words, with no detailed description of the geometric structure and arrangement of the highly numerous individual grains in the material).

In the second step of the method, step b), at the end of the inter-pass I₁ proportions of recrystallised and non-recrystallised grains, as well as a representative grain size and a representative dislocation density, both for the recrystallised grains and non-recrystallised grains, are determined (i.e.: are defined, by computing them) using the above-mentioned model. This determination is carried out taking into account process input parameters measured during or before the first rolling pass. These measured input parameters may comprise one or more of:
an entry temperature of the steel product, measured at an input of the hot roll mill,
an entry thickness of the steel product at an input of the mill,
an exit thickness of the steel product after the first rolling stand,
a speed of the steel product,
an interpass time for the first interpass,
a force exerted by the first rolling stand F1 on the steel product,
a gap between two working of the first rolling stand F1, and
an exit tension (after the first rolling stand.

The above-mentioned microstructure features may be determined taking also into account a chemical composition of the steel product, a diameter of a working roll of the stand and a Young modulus of the material it is made of. The above-mentioned microstructure features are determined taking into account the initial representative grain size ø₀.

In step b), a proportion in the microstructure G_{R}, a representative grain size ø_{R}, and representative a dislocation density pr are defined (in other words determined, by computing them) for the recrystallised grains g_{R}. Also, in step b), a proportion in the microstructure G_{N}, a representative grain size ø_{N}, and a representative dislocation density ρₙ are defined (determined) for the non-recrystallised grains g_{N}.

The representative values can be any value deemed representative by the person skilled in the art. For example, the representative values can be the mean or the median value.

Preferably, the representative values of said representative recrystallised grain take into account the grains being recrystallised by the dynamic, the post-dynamic and the static recrystallisations as well as the proportion of each said recrystallised grains.

As illustrated in FIG. 2, the steel is then hot rolled in the hot rolling stand F2, wherein similar phenomena as during the first hot rolling pass occur. After, the steel is conveyed through the inter-pass I₂, wherein similar phenomena as during the inter-pass I₁ occur.

Consequently, at the end of the second inter-pass I₂, the microstructure can be predicted (which is done in step c)) by any model deemed appropriate by the person skilled in the art. The model outputs data comprising a proportion of grains non-recrystallised and recrystallised during the second hot rolling pass, as well as a grain size and a dislocation density for said grains.

Preferably, plastic deformation can be modelled using the teaching of Sinclair. Preferably, the dynamic recrystallisation can be modelled by the teaching of Senuma; the static recrystallisation, the recovery and the restoration can be modelled by the teaching of Zurob. Preferably, the growth of the recrystallised grains can be modelled using the teaching of Zenner.

However, due to a different microstructure being hot rolled in the first pass (where all the grains are considered recrystallised, here of size ø₀) and the second pass (where some of the grains have been recrystallised during the first rolling pass, or some others not), the microstructure at the end of the first and at the end of the second inter-passes differ.

Indeed, at the end of the second inter-pass, at least four types of grains can be distinguished. The differentiation is based on the recrystallisation or not of the grains at the end of the first and of the second inter-passes.

Consequently, at the end of the inter-pass, the microstructure can be described as comprising:
grains g_{RR} being recrystallised at the end of said first inter-pass and recrystallised at the end of said second inter-pass,
grains g_{RN} being recrystallised at the end of said first inter-pass and non-recrystallised at the end of said second inter-pass,
grains g_{NR} being non-recrystallised at the end of said first inter-pass and recrystallised at the end of said second inter-pass, and
grains g_{NN} non-recrystallised at the end of said first inter-pass and non-recrystallised at the end of said second inter-pass.

Each type of grains, g_{RR}, g_{RN}, g_{NR} and g_{NN} respectively, is described by a representative grain being defined (characterized) by a representative dislocation density, ρ_{RR}, ρ_{RN}, ρ_{NR} and ρ_{NN} respectively, and a representative grain size, ø_{RR}, ø_{RN}, ø_{NR} and ø_{NN} respectively, and its proportion is noted G_{RR}, G_{RN}, G_{NR} and G_{NN} respectively.

Preferably, the representative values of grains being recrystallised at the end of the second inter-pass, g_{NR} and g_{RR}, take into account the grains being recrystallised by the dynamic, the post-dynamic and the static recrystallisation during the second rolling and the second inter-pass.

The determination of the quantities G_{RR}, G_{RN}, G_{NR}, G_{NN}, ø_{RR}, ø_{RN}, ø_{NR}, ø_{NN}, ρ_{RR}, ρ_{RN}, ρ_{NR}, ρ_{NN}, carried out in step c), may, like here, be achieved taking into account the quantities G_{R}, G_{N}, ø_{R}, ø_{N}, ρ_{R}, ρ_{N}, previously determined in step b).

The determination of the quantities G_{RR}, G_{RN}, G_{NR}, G_{NN}, ø_{RR}, ø_{RN}, ø_{NR}, ø_{NN}, ρ_{RR}, ρ_{RN}, ρ_{NR}, ρ_{NN}, carried out in step c), may, like here, be achieved taking also into account process input parameters relative to the second rolling pass, measured during or before the second rolling pass. These measured input parameters may comprise one or more of:
an entry temperature of the steel product, measured at an input of the hot roll mill,
a temperature of the steel product, measured between the first and second rolling pass,
a thickness of the steel product between the first and second rolling pass,
an exit thickness of the steel product after the second rolling,
a speed of the steel product,
an interpass time for the second interpass,
a force exerted by the second rolling stand F2 on the steel product,
a gap between two working rolls of the second rolling stand F2, and
an exit tension.

In step c), the above-mentioned microstructure features may be determined taking also into account the chemical composition of the steel product, a diameter of a working roll of the second stand and a Young modulus of the material it is made of.

It has been observed by the inventors that if the same modelling occurs for the following pass, the number of types of grains, i.e. phases, at the end of the inter-pass n is of 2ⁿ. Each type of grains is defined (characterized) by a (representative) grain size, a (representative) dislocation density and a proportion in the microstructure. However, such a complexity appeared to be problematic for process-products models to be used on-line, for instance for controlling the hot rolling mill. Besides, apart from the computing-time issues, such a model, in which the number of phases exponentially increases with the number of passes, would be hyper-parametrized. Its calibration would thus be hard to achieve and possibly not accurate or not reliable. To solve these issues, models averaging the phase properties at the end of each inter-pass have been developed. Unfortunately, they poorly predicted the final microstructure heterogeneities.

To this end, the present invention comprises an optimised averaging step, step d), able to reduce the number of parameters representing the microstructure.

This is done in step d) by determining a representative recrystallised grain g_{R2} and a representative non-recrystallised grain g_{N2} and proportions thereof G_{R2} and G_{N2}, as illustrated in FIG. 2.

The features of the representative recrystallised grain g_{R2}, namely its representative size ø_{R2} and dislocation density ρ_{R2}, are defined (determined, by computing them) based on the proportions G_{RR}, G_{NR}, the representative grain sizes ø_{RR}, ø_{NR} and the representative dislocation densities ρ_{RR}, ρ_{NR} of the grains g_{RR}, g_{NR} having recrystallised in the second inter-pass.

ø_{R2} is determined by averaging the set of sizes {ø_{RR}, ø_{NR}}, this averaging takin into account the respective proportions G_{RR}, G_{NR} or the grains g_{RR}, g_{NR}. In particular, ø_{R2} may be determined by computed a weighted arithmetic mean of ø_{RR}, ø_{NR}, the weighting coefficients being G_{RR} and G_{NR}:

$${ϕ}_{R 2} = ( {G}_{RR} . {ϕ}_{RR} + {G}_{NR} . {ϕ}_{NR} ) / ( {G}_{RR} + {G}_{NR} ) .$$

ρ_{R2} may be determined in the same manner, but based on ρ_{RR}, ρ_{NR}, G_{RR} and G_{NR}.

G_{R2} is determined for instance by summing G_{RR} and G_{NR}: G_{R2}=G_{RR}+G_{NR}.

The features of the representative non-recrystallised grain g_{N2}, namely its representative size ø_{N2} and dislocation density ρ_{N2}, are defined (determined, by computing them) based on the proportions G_{NN}, G_{RN}, the representative grain sizes ø_{NN}, ø_{RN} and the representative dislocation densities ρ_{NN}, ρ_{RN} of the grains g_{NN}, g_{RN} not having recrystallised in the second inter-pass. This determination is achieved for instance in the same manner as above explained for the features of the representative recrystallised grain g_{R2}.

Consequently, in step d), a proportion in the microstructure G_{R2}, a representative grain size ø_{R2}, and representative dislocation density ρ_{R2} are defined (determined, by computing them) for the grains recrystallised at the second rolling and second inter-pass. Also, in step d) a proportion in the microstructure G_{N2}, a representative grain size ø_{N2}, and representative dislocation density ρₙ₂ are defined (are determined, by computing them) for the grains not recrystallised at the second rolling nor at the second inter-pass.

It is noted that, thanks to this averaging procedure, the situation just before the third pass (third rolling and third interpass) is similar to the situation just before the second pass (second rolling and second interpass) except that the initial quantities G_{R}, G_{N}, ø_{R}, ø_{N}, ρ_{R}, ρ_{N} (initial quantities for the second pass) are replaced by G_{R2}, G_{N2}, ø_{R2}, ø_{N2}, ρ_{R2}, ρ_{N2} for the third pass.

The evolution of the microstructure during the third pass is determined as explained above for the second pass, except that the initial quantities G_{R}, G_{N}, ø_{R}, ø_{N}, ρ_{R}, ρ_{N} (initial quantities for the second pass) are replaced by G_{R2}, G_{N2}, ø_{R2}, ø_{N2}, ρ_{R2}, ρ_{N2}. At the end of the third pass, the microstructure thus determined comprises of four types of grains.

The properties of these four types of grains may then be averaged two by two, as above explained, to obtain two representative types of grains, namely a recrystalized one and a non-recrystallized one.

More generally, the hot rolling operation may comprise a total number of passes N (with N typically equal to or higher than 10), each pass comprising a rolling and subsequent interpass (or a subsequent postpass, for the last pass N), each pass being referred to by its number n with n=1 . . . . N. Steps d) and c) may then be executed iteratively, one time for each pass n, for n=3 . . . . N. In this case, for each pass n, with n=3 . . . . N:
step d) is executed, to determine G_{Rn-1}, G_{Nn-1}, ø_{Rn-1}, ø_{Nn-1}, ρ_{Rn-1}, ρ_{Nn-1} using the averaging procedure above-described; for pass n, these averaged quantities are determined based on the following quantities, determined during the previous execution of step c) (i.e.: during the execution of step c) for the pass n−1): G_{NNn-1}, ø_{RRn-1}, ø_{RNn-1}, ø_{NRn-1}, ø_{NNn-1}, ρ_{RRn-1}, ρ_{RNn-1}, ρ_{NRn-1}, ρ_{NNn-1}; and then
step c) is executed, as above described for the second pass (pass 2) except that the initial quantities, on which step c) is based for pass n, are the quantities G_{Rn-1}, G_{Nn-1}, ø_{Rn-1}, ø_{Nn-1}, ρ_{Rn-1}, ρ_{Nn-1} (instead of G_{R}, G_{N}, ø_{R}, ø_{N}, ρ_{R}, ρ_{N}), and except that the process parameters taken into account may be different than for pass 2; during this execution of step c), the following quantities are determined: G_{RRn}, G_{RNn}, G_{NRn}, G_{NNn}, ø_{RRn}, ø_{RNn}, ø_{NRn}, ø_{NNn}, ρ_{RRn}, ρ_{RNn}, ρ_{NRn}, ρ_{NNn} (similarly as for G_{RR}, G_{RN}, G_{NR}, G_{NN}, ø_{RR}, ø_{RN}, ø_{NR}, ø_{NN}, ρ_{RR}, ρ_{RN}, ρ_{NR}, ρ_{NN} for pass 2).

Preferably, said hot rolling is performed in a reversible mill comprising one reversible rolling stand.

Even more preferably, in said step a), the hot rolling stand 1 is said reversible rolling stand, and in said step b), the inter-pass I₁ extends between the first hot rolling and the second hot rolling in said reversible rolling stand, and in said steps c) and d), the inter-pass I₂ extends between the second hot rolling and the third hot rolling in said reversible rolling stand.

Preferably, said hot rolling is performed in a tandem mill comprising at least three hot rolling stands.

Even more preferably, in said step a), the hot rolling stand F1 is the first rolling stand, in said step b), the inter-pass I₁ extends between the first hot rolling in the first stand and the second hot rolling in the second stand and in said steps c) and d), the inter-pass I₂ extends between the second hot rolling in the second rolling stand and the third hot rolling in the third rolling stand.

Preferably, the recrystallised grains in step b) can result from a dynamic recrystallisation and/or a post-dynamic recrystallisation and/or a static recrystallisation.

Alternatively, the recrystallised grains in step b) can result only from a static recrystallisation.

Preferably, the recrystallised grains in step c) can result from a dynamic recrystallisation and/or a post-dynamic recrystallisation and/or a static recrystallisation.

Alternatively, the recrystallised grains in step c) can result only from a static recrystallisation.

Exemplary test results are presented in FIG. 3. In FIG. 3, an average grain size at the end of the hot rolling, as determined according to the instant method, is plotted against the corresponding measured average grain size (measured directly on a sample taken from the steel product at the end of the hot rolling). The calculated average grain size is the average of the estimated grain sizes after the last pass, that is an average of ø_{RRn=N}, ø_{RNn=N}, ø_{NRn=N} and ø_{NNn=N} (the average being a weighted average, the weighting factors being G_{RRn=N}, G_{RNn=N}, G_{NRn=N}, G_{NNn=N}). The process input parameters, that is the hot rolling conditions, vary from one point to the other in FIG. 3. FIG. 3 illustrates that an approximation on which the instant method is based, which corresponds to the averaging achieved in step d), is a good approximation. Indeed, it allows for simplifying a lot the computation while leading to accurate predictions, as illustrated in FIG. 3.

In the exemplary embodiment of the method described above, the characteristics of the microstructure of the steel product, at the end of the hot rolling (i.e.: after pass N) or at an intermediary stage of the hot rolling (after pass n, n=3 . . . . N−1), are determined based on process parameters, so called process input parameters, actually applied when executing said hot rolling. These process parameters are either measured by sensors fitted on the hot rolling mill, or derived from control signals sent to actuators of the hot rolling mill. So, in this exemplary embodiment of the method, the method is a non-direct measurement method enabling to determine characteristics of the produced steel product (namely characteristics of its microstructure), from measurements (measurements of the process parameters) or control signals actually applied, using a model.

This non-direct measurement method may be further applied:
to control (in real time) the operation of the hot rolling mill, or
to determine mechanical properties of the hot rolled semi-product, based on its microstructure.

### Control of the Hot Rolling Mill.

Knowing the characteristics of the microstructure, in terms of grain proportions, sizes, and dislocation densities, is very useful for controlling the rolling stand(s) of the mill. Indeed, theses quantities strongly influence the plasticity and formability of the semi-product. And so, for each rolling pass, the thickness after rolling, or the reduction ratio, depends usually both on the rolling parameters (such as the gap between rolls), and on the microstructure just before the rolling operation.

In practice, when the microstructure is to not taken into account, failing to obtain the targeted thickness is rather usual when a new kind of product is rolled on a hot rolling mill (because the material contained a small proportion of recrystallised grains and was thus stiffer than expected, or on the contrary because the material was softer than expected). By new kind of product, it is meant a product made of a type of steel that has not been previously rolled on the hot rolling mill, and for which no experience has been acquired regarding its behaviour when being hot rolled (for instance a steel with residual contents different than the usual ones, for the steel making line considered, or for which the process parameters employed upstream of the hot rolling are different than the ones usually used on this steel making line).

It is thus very useful to control the mill, during one or more of the N passes, taking into account the characteristics of the microstructure determined as above explained, as it enables to estimate reliably the formability of the product, should it be a new kind of product, or a regular one.

More particularly, according to a first application of the instant method, the rolling stand performing the pass n is controlled, or in other words regulated, taking G_{Rn-1}, G_{Nn-1}, ø_{Rn-1}, ø_{Nn-1}, ρ_{Rn-1}, ρ_{Nn-1} into account, or, alternatively, taking G_{NNn-1}, ø_{RRn-1}, ø_{RNn-1}, ø_{NRn-1}, ø_{NNn-1}, ρ_{RRn-1}, ρ_{RNn-1}, ρ_{NRn-1}, ρ_{NNn-1} into account.

For instance, the third rolling pass may be regulated using G_{R2}, ø_{R2}, ρ_{R2}, G_{N2}, ø_{N2}, ρ_{N2}.

The regulation of the pass n is typically achieved taking also into account process inputs parameters relative to pass n, such as: a current speed of the product, a temperature upstream and/or downstream of the working rolls of the rolling stand achieving the pass n, a current force exerted by the stand on the steel product, a current gap between working rolls, a current rotation speed of the working rolls, a thickness upstream the stand achieving pass n. It may also take into account the chemical composition of the product, and rolling mill characteristics such as the working roll diameter and associated Young modulus. These different parameters and characteristics may be measured (it is the case for the product speed, or its temperature), or pre-recorded or otherwise acquired (like it is the case for the working roll diameter, for instance).

The regulation of the rolling stand performing the pass n may comprise determining one or more process setpoints, based on:
the microstructure characteristics (for instance, G_{Rn-1}, G_{Nn-1}, ø_{Rn-1}, ø_{Nn-1}, ρ_{Rn-1}, ρ_{Nn-1}),
the one or more process input parameters, and other parameters or characteristics mentioned in the paragraph above, and
a target exit thickness or reduction ratio, to be obtained after pass n.

The one or more process setpoints may comprise one or more of the following: a setpoint force, to be exerted by the stand on the product, a setpoint gap between working rolls, and a setpoint rotation speed of the working rolls.

The one or more process setpoints are transmitted to one or more controllers or actuators of the stand achieving the pass n, so that the pass n is achieved according to said setpoint(s).

The regulation of the rolling stand performing the pass n may comprise determining a mean flow stress, to be applied during the pass n, the mean flow stress being computed based on the values of G_{Rn-1}, G_{Nn-1}, ø_{Rn-1}, ø_{Nn-1}, ρ_{Rn-1}, ρ_{Nn-1}. For instance, a mean flow stress to be applied during the third rolling pass may be determined (by computing) using G_{R2}, ø_{R2}, ρ_{R2}, G_{N2}, ø_{N2}, ρ_{N2} and process inputs parameters.

The determination of the mean flow stress may be achieved according to equations (6) and (7) of Lissel et al., for instance. A so-called friction-hill roll-force model can also be used to determine the mean flow stress to be applied. The friction-hill roll-force model employed may be the Orowan model. However, it can also be any other model known to a person skilled in the art, such as the Sims or Bland & Ford models. The general theory of each of these three models is described, for example, in “The calculation of roll pressure in hot and cold flat rolling,” E. Orowan, Proceedings of the Institute of Mechanical Engineers, June 1943, Vol. 150, No. 1, pp. 140-167 for the Orowan model, “The calculation of roll force and torque in hot rolling mills,” R. B. Sims, Proceedings of the Institute of Mechanical Engineers, June 1954, Vol. 168, No. 1, pp. 191-200 for the Sims model, The Calculation of Roll Force and Torque in Cold Strip Rolling with Tensions,” D. R. Bland and H. Ford, Proceedings of the Institute of Mechanical Engineers, June 1948, Vol. 149, p. 144, for the Bland & Ford model. The friction-hill roll force model may be employed to further determine the process setpoints to be employed, such as the force to be exerted and/or the rotation speed.

In the exemplary embodiment described here, each rolling pass n (with n from 1 to N) is regulated using the regulation technique above described. Still, alternatively, just some of the rolling passes, or possibly just one rolling pass (for instance one or more rolling passes with n≥3) could be regulated in this way, based on the estimated microstructure characteristics.

### Determination of Mechanical Properties of the Hot Rolled Semi-Product

According to a second application of the instant method, the characteristics of the microstructure of the steel product at the end of the hot rolling, that is after the last rolling pass (i.e.: after pass N), namely G_{RRn=N}, G_{RNn=N}, G_{NRn=N}, G_{NNn=N}, ø_{RRn=N}, ø_{RNn=N}, ø_{NRn=N}, ø_{NNn=N}, ρ_{RRn=N}, ρ_{RNn=N}, ρ_{NRn=N}, ρ_{NNn=N} (possibly further averaged two-by-two, as above explained), are taken into account to determine a subsequent evolution of the microstructure of steel product, during subsequent cooling on a run-out-table and possibly during a subsequent hot coiling.

To determine said subsequent evolution of the microstructure of steel product, it is of course useful to know the microstructure characteristics just after the hot rolling, as a starting point for further transformations. The determination of the subsequent evolution may be carried on according to any adequate process-product model for the run-out-table cooling (and possibly for the hot coiling), for instance according to paragraph 101 of EP3645182B1. One or more mechanical properties of the hot coiled coil thus obtained may then be determined, based on said final microstructure. By mechanical property, it is meant one of the yield strength YS, the Ultimate Tensile Strength UTS, the elongation, the hole expansion, the formability. To determine the one or more mechanical properties from the final microstructure, and chemical composition, different existing models, known by the skilled person, can be employed, depending on the grade of the steel considered. In particular, this determination may be based on the model described in the following article by S. Allain et al.: “Microstructure based modeling for the mechanical behavior of ferrite-pearlite steels suitable to capture isotropic and kinematic hardening”, Materials Science and Engineering: A, Volume 496, Issues 1-2, 25 Nov. 2008, Pages 329-336, ISSN 0921-5093; for instance based on eqn 1 to 4 of this article, or based on the more elaborate version of these equations presented in section 3 of this article (eqn 5 to 15).

It is noted that determining mechanical properties of a steel product, based on process parameters employed during the manufacturing and based on a metallurgical model is indeed of practical interest. In this respect, a euronorm (EN10373) even specifies in which conditions coils mechanical properties can be specified to customers, based on such model-computations instead of being based on direct mechanical tests, which illustrates the actual industrial utility of such model-based mechanical properties determinations.

The instant method, for determining characteristics of a microstructure of a semi-finished steel product during a hot rolling, is executed by an electronic device having the structure of a computer. The electronic device comprises at least a processor and a memory. It comprises also a non-transitory computer-readable medium, such as a hard drive or a flash memory, which comprises instructions (more precisely a computer program comprising of these instructions) whose execution by the electronic device makes the electronic device to execute said method for determining the characteristics of the microstructure of the steel product.

The electronic device further comprises a communication interface, for receiving data, more particularly for receiving the process input parameters above mentioned.

In the embodiment considered here, the electronic device also comprises a human-machine interface, such as computer display, and it is configured for outputting one or more of the characteristics of the microstructure determined by the electronic device, using the human-machine interface.

When the electronic device is employed for controlling the hot rolling mill, its communication interface is connected to sensors of the hot rolling mill (for instance to temperature, speed or thickness sensors) and/or to a controller or actuators of the hot rolling mill for receiving data representative of process parameters (such as a force exerted on the product, or a rotation speed).

This connection may be a wire or wireless connection. It may be achieved using a local network or bus, for instance of the CAN (Controller Area Network), CAN+ or fieldbus type. It may also be achieved using a public network like the internet.

When the electronic device is employed for controlling the hot rolling mill, its communication interface is also connected to a controller of the mill and/or to actuators of the mill, to which the setpoints above mentioned are transmitted, for controlling the hot-rolling passes.

When the electronic device is employed for determining one or more mechanical characteristics of the steel product, its communication interface may be connected to sensors and/or actuators of the mill, in order to acquire the process input parameters.

Alternatively, it may be connected to an industrial production database, in which such parameters are recorded during manufacturing. In this last case, the process input parameters are acquired by the electronic device a-posteriori, after the hot-rolling of the steel product.

When the electronic device is employed for determining one or more mechanical characteristics of the steel product, the electronic device may be configured for outputting said mechanical properties using its communication interface, so that the one or more mechanical characteristics are stored in the above-mentioned industrial database. Alternatively or in complement, it may be configured for outputting the one or more mechanical characteristics using the human-machine interface of the electronic device.

In the example presented above the electronic device has the structure of a stand-alone computer or electronic calculator. Still, in alternative embodiments, the electronic device may take the form of a distributed computer system, comprising for instance two or more computers operatively connected to each other, or comprising remote and possibly distributed computing resources such as cloud computing resources.

1-22. (canceled)

23. A method for determining characteristics of a microstructure of a semi-finished steel product during a hot rolling comprising at least three passes, the method comprising the steps of:
a) acquiring a representative grain size value for the steel product before a first rolling pass,
b) determining, at the end of a first inter-pass I₁,
a proportion G_{R} of recrystallised grains g_{R}, and a proportion G_{N} of non-recrystallised grains g_{N},
representative grain sizes ø_{R}, ø_{N}, and representative dislocation densities ρ_{R}, ρ_{N}, for the recrystallised grains g_{R} and the non-recrystallised grains g_{N},
c) determining, at the end of a second inter-pass I₂,
a proportion G_{RR} of grains g_{RR}, being recrystallised at the end of the first inter-pass I₁, and recrystallised at the end of the second inter-pass I₂,
a proportion G_{RN} of grains g_{RN}, being recrystallised at the end of the first inter-pass I₁ and non-recrystallised at the end of the second inter-pass I₂,
a proportion G_{NR} of grains g_{NR}, being non-recrystallised at the end of the first inter-pass I₁ and recrystallised at the end of the second inter-pass I₂,
a proportion G_{NN} of grains g_{NN} non-recrystallised at the end of the first inter-pass I₁ and non-recrystallised at the end of the second inter-pass I₂,
representative grain sizes ø_{RR}, ø_{RN}, ø_{NR}, ø_{NN}, and representative dislocation densities ρ_{RR}, ρ_{RN}, ρ_{NR}, ρ_{NN}, of the grains g_{RR}, G_{RN}, g_{NR}, I_{NN},
d) determining, before a third rolling pass, the following characteristics of the microstructure of the semi-finished steel product:
a proportion G_{R2} of representative recrystallised grains g_{R2}, and a proportion G_{N2} of representative non-recrystallised grains g_{N2},
for the representative recrystallised grains g_{R2}: a grain size ø_{R2} and a dislocation density ρ_{R2} based on the grain proportions G_{RR}, G_{NR}, the representative grain sizes ø_{RR}, ø_{NR} and the dislocation densities ρ_{RR}, ρ_{NR} of the grains g_{RR} and g_{NR},
for the representative non-recrystallised grains g_{N2}: a grain size ø_{N2} and a dislocation density ρ_{N2} based on the grain proportions G_{NN}, G_{RN}, the representative grain sizes ø_{RN}, ø_{NN} and the dislocation densities ρ_{NN}, ρ_{RN} of the grains g_{RN} and g_{NN}.

24. The method as recited in claim 23,
further comprising acquiring one or more of the following process input parameters, measured during or before the hot rolling:
an entry temperature of the steel product, measured at an input of a hot roll mill employed to achieve the hot rolling,
an entry thickness of the steel product at an input of the mill,
a speed of the steel product,
an interpass time for the first or second interpass,
a force exerted by a roll of the mill,
a gap between two working rolls of the mill,
an exit tension,
and wherein, in step b) and c), one or more of the following quantities: G_{R}, G_{N}, ø_{R}, ø_{N}, ρ_{R}, ρ_{N}, G_{RR}, G_{RN}, G_{NR}, G_{NN}, ø_{RR}, ø_{RN}, ø_{NR}, ø_{NN}, ρ_{RR}, ρ_{RN}, ρ_{NR}, ρ_{NN}, is determined based on the one or more process input parameters.

25. The method as recited in claim 23, further comprising:
e) outputting the proportions G_{R2}, G_{N2} and the representative grain sizes ø_{R2}, ø_{N2} and the dislocations densities ρ_{R2}, ρ_{N2} to an operator on a computer display.

26. The method as recited in claim 23, further comprising:
e′) recording in an industrial production database one or more of: the proportions G_{R2}, G_{N2} and the representative grain sizes ø_{R2}, ø_{N2} and the dislocations densities ρ_{R2}, ρ_{N2}.

27. The method as recited in claim 23, wherein the hot rolling is performed in a reversible mill comprising one reversible rolling stand.

28. The method as recited in claim 23, wherein the hot rolling is performed in a tandem mill comprising at least three hot rolling stands.

29. The method as recited in claim 23, wherein the recrystallised grains in step b) can result from a dynamic recrystallisation and/or a post-dynamic recrystallisation and/or a static recrystallisation.

30. The method as recited in claim 23, wherein the recrystallised grains in step b) can only result from a static recrystallisation.

31. The method as recited in claim 23, wherein the recrystallised grains in step c) can result from a dynamic recrystallisation or a post-dynamic recrystallisation or a static recrystallisation.

32. The method as recited in claim 31, wherein the wherein the recrystallised grains in step c) can only result from a static recrystallisation.

33. The method as recited in claim 24, wherein a hot rolling stand performing the third pass is regulated using G_{R2}, ø_{R2}, ρ_{R2}, G_{N2}, ø_{N2}, ρ_{N2} determined in step d).

34. The method as recited in claim 33, wherein a mean flow stress to be applied during the third rolling pass is determined using the G_{R2}, ø_{R2}, ρ_{R2}, G_{N2}, ø_{N2}, ρ_{N2} determined in step d).

35. The method as recited in claim 34, wherein a mean flow stress to be applied during the third rolling pass is determined using one or more process inputs parameters relative to the third pass.

36. The method as recited in claim 23, wherein the hot rolling comprises from 10 to 15 hot rolling passes and produces a steel strip.

37. The method as recited in claim 23, wherein the hot rolling comprises from 15 to 35 hot rolling passes and produces a steel plate.

38. The method as recited in claim 23, wherein the hot rolling comprises a total number of passes N, each pass comprising a rolling and a subsequent interpass or postpass, each pass being referred to by its number n with n=1 . . . N, and wherein steps d) and c) are executed iteratively, one time for each pass n with n=3 . . . N, wherein,
during the execution of step d) for the pass n, proportions G_{Rn-1}, G_{Nn-1}, sizes ø_{Rn-1}, ø_{Nn-1}, and dislocation densities ρ_{Rn-1}, ρ_{Nn-1} of representative grains g_{Rn-1}, g_{Nn-1} are determined, by averaging, based on the following quantities, determined during the previous execution of step c) achieved for the pass n−1: G_{NNn-1}, ø_{RRn-1}, ø_{RNn-1}, ø_{NRn-1}, ø_{NNn-1}, ρ_{RRn-1}, ρ_{RNn-1}, ρ_{NRn-1}, ρ_{NNn-1}; and then
during the execution of step c) for the pass n, the following quantities are determined, based on G_{Rn-1}, G_{Nn-1}, ø_{Rn-1}, ø_{Nn-1}, ρ_{Rn-1}, ρ_{Nn-1}: G_{RRn}, G_{RNn}, G_{NRn}, G_{NNn}, ø_{RRn}, ø_{RNn}, ø_{NRn}, ø_{NNn}, ρ_{RRn}, ρ_{RNn}, ρ_{NRn}, ρ_{NNn}.

39. The method as recited in claim 38,
further comprising acquiring one or more of the following process input parameters, measured during or before the hot rolling:
an entry temperature of the steel product, measured at an input of a hot roll mill employed to achieve the hot rolling,
an entry thickness of the steel product at an input of the mill,
a speed of the steel product,
an interpass time for the first or second interpass,
a force exerted by a roll of the mill,
a gap between two working rolls of the mill,
an exit tension,
and wherein, in step b) and c), one or more of the following quantities: G_{R}, G_{N}, ø_{R}, ø_{N}, ρ_{R}, ρ_{N}, G_{RR}, G_{RN}, G_{NR}, G_{NN}, ø_{RR}, ø_{RN}, ø_{NR}, ø_{NN}, ρ_{RR}, ρ_{RN}, ρ_{NR}, ρ_{NN}, is determined based on the one or more process input parameters; and
wherein, for the pass n at least, with n higher than or equal to 3, the hot rolling stand performing the pass n is regulated:
based on the following quantities determined during the execution of step d) for the pass n: G_{Rn-1}, G_{Nn-1}, ø_{Rn-1}, ø_{Nn-1}, ρ_{Rn-1}, ρ_{Nn-1}, or,
based on the following quantities determined during the execution of step c) for the pass n−1: G_{NNn-1}, ø_{RRn-1}, ø_{RNn-1}, ø_{NRn-1}, ø_{NNn-1}, ρ_{RRn-1}, ρ_{RNn-1}, ρ_{NRn-1}, ρ_{NNn-1}.

40. The method as recited in claim 39, wherein the pass n is regulated taking also into account one or more process input parameters relative to the pass n.

41. The method as recited in claim 38,
further comprising acquiring one or more of the following process input parameters, measured during or before the hot rolling:
an entry temperature of the steel product, measured at an input of a hot roll mill employed to achieve the hot rolling,
an entry thickness of the steel product at an input of the mill,
a speed of the steel product,
an interpass time for the first or second interpass,
a force exerted by a roll of the mill,
a gap between two working rolls of the mill,
an exit tension,
and wherein, in step b) and c), one or more of the following quantities: G_{R}, G_{N}, ø_{R}, ø_{N}, ρ_{R}, ρ_{N}, G_{RR}, G_{RN}, G_{NR}, G_{NN}, ø_{RR}, ø_{RN}, ø_{NR}, ø_{NN}, ρ_{RR}, ρ_{RN}, ρ_{NR}, ρ_{NN}, is determined based on the one or more process input parameters; and
further comprising determining one or more mechanical properties the steel product has, after the hot rolling, the one or more mechanical properties being determined from the following microstructure characteristics the steel product has after the last pass N: G_{RRn=N}, G_{RNn=N}, G_{NRn=N}, G_{NNn=N}, ø_{RRn=N}, ø_{RNn=N}, ø_{NRn=N}, ø_{NNn=N}, ρ_{RRn=N}, ρ_{RNn=N}, ρ_{NRn=N}, ρ_{NNn=N}.

42. Electronic device, comprising at least a processor and a memory, configured for executing the method as recited in claim 23.

43. A hot rolling mill comprising one or more rolling stands and the electronic device as recited in claim 42.

44. A computer program comprising instructions to execute the method as recited in claim 42 on a computer.
